(19) United States
(12) Patent Application Publication
(10) Pub. No.: US 2025/0135935 A1
(43) Pub. Date: May 1, 2025

(54) CHARGING SYSTEM

(71) Applicant: Caterpillar Inc., Peoria, IL (US)

(72) Inventors: Tryg Carl Tow, Peoria, IL (US); Craig P. Hittle, Dunlap, IL (US)

(73) Assignee: Caterpillar Inc., Peoria, IL (US)

(21) Appl. No.: 18/497,094

(22) Filed: Oct. 30, 2023

(51) Int. Cl. B60L 53/54; B60K 15/03; B60L 50/75; B60L 53/18; B60L 53/57; B60P 3/06; H01M 8/04082; H01M 8/10; H01M 10/46; H01M 16/00

(52) U.S. Cl. CPC B60L 53/54; B60K 15/03006; B60L 50/75; B60L 53/18; B60L 53/57; B60P 3/062; H01M 8/04201; H01M 10/46; H01M 16/006; B60K 2015/03315; B60L 2200/40; H01M 2008/1095; H01M 2250/20

(57) ABSTRACT

A charging system includes a work machine. The work machine includes a battery system. The charging system also includes a transport vehicle adapted to transport the work machine. The work machine is positioned on the transport vehicle for transportation thereof. The transport vehicle includes a fuel cell system. The fuel cell system of the transport vehicle provides operating power to the transport vehicle for propelling the transport vehicle. The fuel cell system further provides an electric power supply to the battery system of the work machine for charging the battery system.

### TECHNICAL FIELD

The present disclosure relates to a charging system, a transport vehicle for transporting a work machine, and a method of charging the work machine.

### BACKGROUND

An electric powered work machine, such as an electric excavator, includes a battery system that supplies electric power to one or more components of the work machine in order to perform work operations at a worksite.

It may be desirable that the battery system of the work machine is charged before the commencement of a work shift, so as to reduce machine downtime. Further, the work machine may consume electric power to perform work operations that may eventually deplete the electric power stored in the battery system. In order to continue work operations, the battery system may have to be periodically recharged.

In some cases, the work machine may perform work operations at locations that may have limited access to grid power. Further, the work machine may require a conventional grid connected charger for recharging the battery system. In some cases, the battery system may be charged via a fuel cell system. The fuel cell system uses hydrogen as a fuel to produce electric power. The fuel cell system may include hydrogen tanks with hydrogen stored therein. Such a fuel cell system may have to be transported to the worksite via a truck in order to recharge the battery system. As the fuel cell system and hydrogen tanks may be costly to manufacture and transport to the worksite, such charging options may increase overall operational costs associated with work operations.

DE102017203924 discloses a system and a method for charging a battery-electric motor vehicle (BEV). A parked vehicle with a fuel cell is used as a quick charging station for a BEV. However, the parked vehicle may have to be separately transported to different worksites in order to facilitate charging of the battery-electric motor vehicle.

### SUMMARY OF THE DISCLOSURE

In an aspect of the present disclosure, a charging system is provided. The charging system includes a work machine. The work machine includes a battery system. The charging system also includes a transport vehicle adapted to transport the work machine. The work machine is positioned on the transport vehicle for transportation thereof. The transport vehicle includes a fuel cell system. The fuel cell system of the transport vehicle provides operating power to the transport vehicle for propelling the transport vehicle. The fuel cell system further provides an electric power supply to the battery system of the work machine for charging the battery system.

In another aspect of the present disclosure, a transport vehicle for transporting a work machine is provided. The transport vehicle includes a fuel cell system. The fuel cell system of the transport vehicle provides operating power to the transport vehicle for propelling the transport vehicle. The fuel cell system further provides an electric power supply to the battery system of the work machine for charging the battery system. The transport vehicle also includes a cable to supply the electric power supply from the fuel cell system to the battery system. The cable has a first end and a second end. The first end of the cable is coupled to the fuel cell system of the transport vehicle and the second end of the cable is coupled to the battery system of the work machine.

In yet another aspect of the present disclosure, a method of charging a work machine is provided. The work machine includes a battery system. The method includes providing a transport vehicle. The transport vehicle is adapted to transport the work machine. The work machine is positioned on the transport vehicle for transportation thereof. The transport vehicle includes a fuel cell system. The method also includes operating the fuel cell system of the transport vehicle to provide operating power to the transport vehicle for propelling the transport vehicle. The method further includes operating the fuel cell system of the transport vehicle to provide an electric power supply to the battery system of the work machine.

Other features and aspects of this disclosure will be apparent from the following description and the accompanying drawings.

### BRIEF DESCRIPTION OF THE DRAWINGS

FIG. 1 is a schematic view illustrating a charging system charging a work machine during a transportation of the work machine, according to an example of the present disclosure;

FIG. 2 is a schematic view illustrating the charging system of FIG. 1 charging the work machine of FIG. 1 at a worksite, according to another example of the present disclosure;

FIG. 3 is a block diagram illustrating the charging system of FIG. 1 charging multiple work machines at the worksite, according to yet another example of the present disclosure; and

FIG. 4 is a flowchart for a method of charging the work machine, according to an example of the present disclosure.

### DETAILED DESCRIPTION

Wherever possible, the same reference numbers will be used throughout the drawings to refer to the same or like parts.

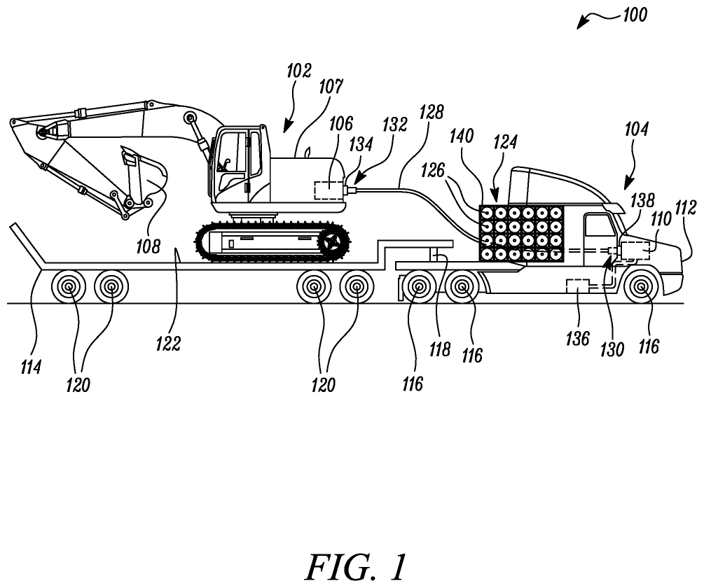

Referring to FIG. 1, a schematic view of a charging system 100 is illustrated. The charging system 100 includes a work machine 102. The work machine 102 may be transported between various worksites, as per requirements. In some examples, the work machine 102 includes an off-highway machine. Specifically, in the illustrated example of FIG. 1, the work machine 102 is embodied as an excavator. Alternatively, the work machine 102 may be embodied as any other electric construction machine or power tool, such as a dozer, a grader, a forklift, and the like, as per application requirements.

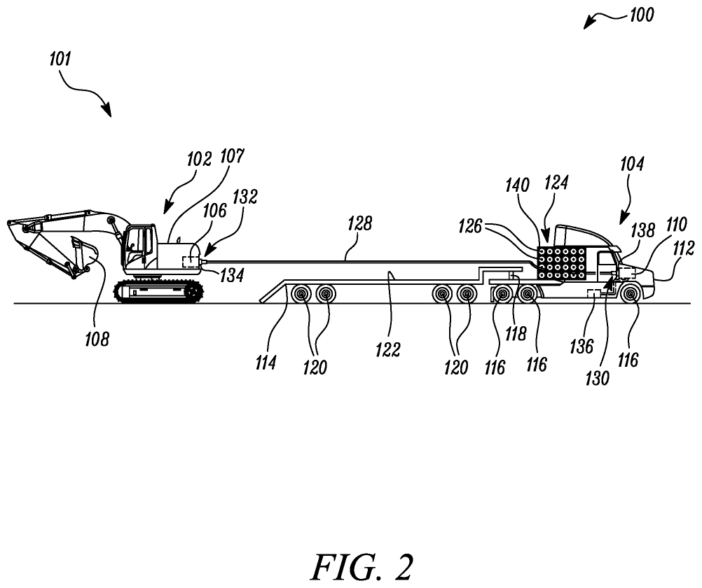

The work machine 102 includes a battery system 106. The battery system 106 is embodied as an electricity storage device for supplying electric power to one or more components of the work machine 102. For example, the battery system 106 may supply electric power to a motor (not shown) that may allow propulsion of the work machine 102. Further, the electric power from the battery system 106 may also power another motor that may be associated with, for example, an implement 108 of the work machine 102. The implement 108 may perform one or more work operations, such as an excavation operation, at a worksite 101 (shown in FIG. 2). In the illustrated example of FIG. 1, the implement 108 includes a bucket. In other examples, the implement 108 may include any other type of work tool, as per application attributes.

The battery system 106 may include one or more rechargeable lithium-ion batteries to store electric power and distribute the stored electric power at a desired battery module voltage and a desired battery module amperage to one or more components of the work machine 102. In other examples, the battery system 106 may include one or more rechargeable lead-acid batteries, nickel metal hydride (NiMH) batteries, and the like that converts chemical energy to electrical energy.

Further, the electric power stored in the battery system 106 may deplete as the work machine 102 performs the work operations at the worksite 101. Thus, the battery system 106 needs to be charged periodically in order to ensure continued operation of the work machine 102. The battery system 106 requires a source of Direct Current (DC) power for charging thereof. The battery system 106 may include a 12 Volts (V) battery, a 24 V battery, a 48 V battery, or higher, as per a size and operational requirement of the work machine 102. The battery system 106 may output 12 V, 24 V, 48 V of DC power, or higher, as per the size and operational requirements of the work machine 102. The work machine 102 includes an enclosure 107. The battery system 106 is disposed within the enclosure 107.

The charging system 100 also includes a transport vehicle 104 to transport the work machine 102. The transport vehicle 104 may transport the work machine 102 between various worksites. The work machine 102 is positioned on the transport vehicle 104 for transportation thereof. The transport vehicle 104 includes a mobile machine 112 and a trailer 114 that is driven by the mobile machine 112. In some examples, the transport vehicle 104 includes an on-highway vehicle. Specifically, in the illustrated example of FIG. 1, the mobile machine 112 is embodied as a truck. Alternatively, the mobile machine 112 may be embodied as any other vehicle instead of a truck, without any limitations. The mobile machine 112 includes a number of wheels 116 that allow movement of the mobile machine 112 on grounds. In the illustrated example of FIG. 1, the mobile machine 112 includes six wheels 116 disposed on either side of the mobile machine 112. In other examples, the mobile machine 112 may include any number of wheels 116 based on application attributes.

Further, the mobile machine 112 pulls the trailer 114. The trailer 114 is coupled to the mobile machine 112 via a hitch assembly 118 that couples the trailer 114 with the mobile machine 112. The trailer 114 includes a number of wheels 120 that allow movement of the trailer 114. In the illustrated example of FIG. 1, the trailer 114 includes eight wheels 120 disposed on either side of the trailer 114. In other examples, the trailer 114 may include any number of wheels 120 based on application attributes.

Further, the trailer 114 includes a deck 122. The deck 122 allows positioning of one or more components or work machines on the trailer 114 for transportation of such components or work machines. In the illustrated example of FIG. 1, the work machine 102 is positioned on the deck 122 of the trailer 114. In some cases, the trailer 114 may include an enclosed trailer that may include sidewalls, without any limitations. It should be noted that the trailer 114 illustrated herein is exemplary in nature, and the trailer 114 may include any other size or shape, as per application requirements. In other examples, the mobile machine 112 may itself include the deck 122. The trailer 114 may be omitted in such examples.

The transport vehicle 104 includes a fuel cell system 110. The fuel cell system 110 is disposed in the mobile machine 112. The fuel cell system 110 may include, for example, a hydrogen fuel cell. Alternatively, the fuel cell system 110 may include another type of fuel cell, without any limitations. The fuel cell system 110 may include components (not shown), such as, a fuel cell stack having a number of cells disposed within a housing. Each cell of the fuel cell stack may include components, such as, a negative electrode, a positive electrode, an electrolyte membrane, and the like, that may together generate electric power.

The fuel cell system 110 of the transport vehicle 104 provides operating power to the transport vehicle 104 for propelling the transport vehicle 104. The transport vehicle 104 includes a motor 136 electrically coupled to the fuel cell system 110. The fuel cell system 110 drives the motor 136 that in turn drives one or more wheels 116 of the mobile machine 112.

Further, it may be desired that the battery system 106 of the work machine 102 is fully charged before the commencement of a work shift, in order to reduce machine downtime and improve productivity. If the work machine 102 is at a different location and the battery system 106 needs charging, the work machine 102 may have to be transported to the worksite 101 and subsequently charged to ensure continued operation. Such a scenario may cause a delay in work operation, which may affect a productivity at the worksite 101. To address this shortcoming, the fuel cell system 110 further provides an electric power supply to the battery system 106 of the work machine 102 for charging the battery system 106. Particularly, in the illustrated example of FIG. 1, the fuel cell system 110 provides the electric power supply to the battery system 106 of the work machine 102 for charging the battery system 106 during the transportation of the work machine 102. In some examples, the electric power supply includes a direct current (DC) power supply.

The transport vehicle 104 further includes a hydrogen storage system 124 to provide hydrogen fuel to the fuel cell system 110 of the transport vehicle 104. The hydrogen storage system 124 includes one or more hydrogen tanks 126. The hydrogen storage system 124 may include any number of hydrogen tanks 126, based on power requirements. It should be noted that the transport vehicle 104 may be able to hold multiple hydrogen tanks 126. In the illustrated example of FIG. 1, the mobile machine 112 holds the hydrogen tanks 126. Alternatively, or additionally, the hydrogen tanks 126 may be stored on the trailer 114. The multiple hydrogen tanks 126 may be used to supply hydrogen fuel to the fuel cell system 110 that may allow the transport vehicle 104 to travel longer distances and also operate as a charging source for one or more work machines, such as, the work machine 102. The hydrogen storage system 124 also includes a storage rack 140. The storage rack 140 holds and supports the hydrogen tanks 126 and may maintain stability of the hydrogen tanks 126.

The charging system 100 further includes a cable 128 to supply the electric power supply from the fuel cell system 110 to the battery system 106. The cable 128 has a first end 130 and a second end 132. The first end 130 of the cable 128 is coupled to the fuel cell system 110 of the transport vehicle 104 and the second end 132 of the cable 128 is coupled to the battery system 106 of the work machine 102.

The work machine 102 also includes a charging port 134 operatively and electrically connected to the battery system 106 of the work machine 102. The charging port 134 receives electric power supply from the fuel cell system 110. Further, the charging port 134 is shown to be located proximate to a rear end of the work machine 102. However, the charging port 134 may be located elsewhere on the work machine 102, without any limitations. It should be noted that the placement and orientation of the charging port 134 may differ across different vehicle types, makes, and/or models, which may themselves range in size and shape.

Further, the transport vehicle 104 includes a connector 138 operatively and electrically connected to the fuel cell system 110 of the transport vehicle 104. Particularly, in order to transmit the electric power supply to the work machine 102, the second end 132 of the cable 128 is connected to the charging port 134 of the work machine 102 and the first end 130 of the cable 128 is connected to the connector 138 of the transport vehicle 104.

FIG. 2 is a schematic view illustrating the charging system 100 charging the work machine 102 of FIG. 1 at the worksite 101, according to another example of the present disclosure. The fuel cell system 110 provides the electric power supply to the battery system 106 of the work machine 102 for charging the battery system 106 when the work machine 102 is located at the worksite 101 and the transport vehicle 104 is in a parked state. In other words, the battery system 106 may be charged by the fuel cell system 110 when the work machine 102 is not positioned on the transport vehicle 104. For example, when the battery system 106 is to be charged, the transport vehicle 104 may travel towards the work machine 102. Subsequently, the cable 128 may be connected to each of the work machine 102 and the transport vehicle 104 to provide the electric power supply to the battery system 106 for charging the battery system 106.

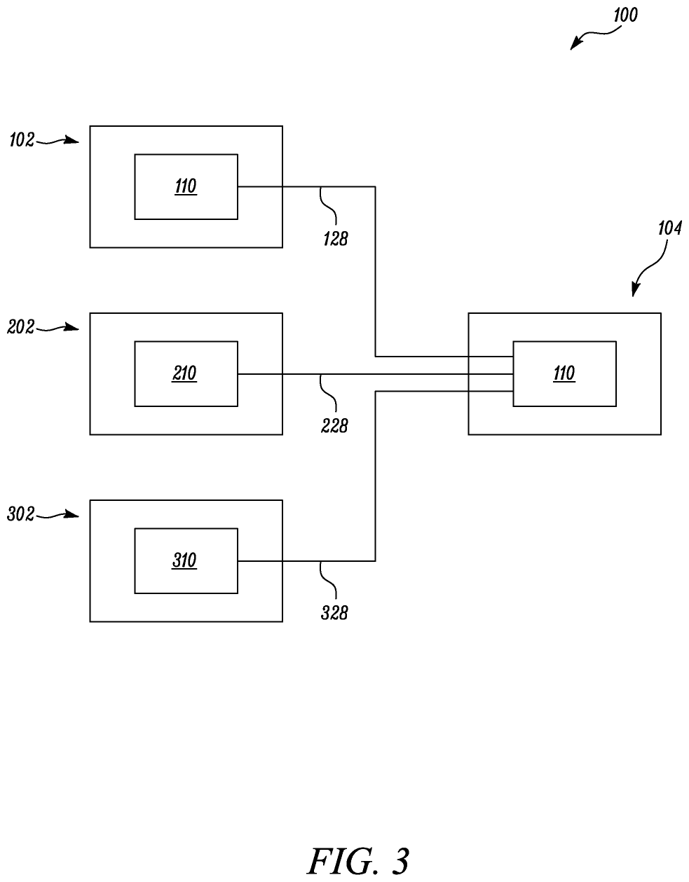

FIG. 3 is a block diagram depicting the charging system 100 charging multiple work machines 102, 202, 302, according to yet another example of the present disclosure. The work machine 202 is a battery-operated work machine having a battery system 206. Further, the work machine 302 is a battery-operated work machine having a battery system 306. The battery systems 206, 306 may be similar in functionality to the battery system 106 explained in relation to FIG. 1. The work machines 202, 302 may be embodied as any machine, such as, a dozer, a grader, and excavator, and the like.

Further, the fuel cell system 110 provides the electric power supply to the battery systems 106, 206, 306 of the two or more work machines 102, 202, 302 for charging the battery systems 106, 206, 306 when the two or more work machines 102, 202, 302 are located at the worksite 101 (see FIG. 2) and the transport vehicle 104 is in the parked state. In other words, the battery systems 106, 206, 306 may be charged by the fuel cell system 110 when the work machines 102, 202, 302 are not positioned on the transport vehicle 104.

The fuel cell system 110 may provide the electric power supply to the battery systems 106, 206, 306 of the two or more work machines 102, 202, 302 simultaneously or in a sequential manner. Specifically, in one example, each of the battery systems 106, 206, 306 may be charged simultaneously. In such examples, the charging system 100 may include cables 228, 328, each of which may be similar to the cable 128, to charge the battery systems 206, 306. FIG. 3 illustrates simultaneous charging of the battery systems 106, 206, 306 of the work machines 102, 202, 302. Further, in another example, the battery systems 106, 206, 306 of the work machines 102, 202, 302 may be charged sequentially, i.e., one after another, based on application requirements.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is directed towards the charging system 100. The charging system 100 includes the transport vehicle 104 that includes the fuel cell system 110. The fuel cell system 110 is used to charge the battery system 106 of the work machine 102. In one example, the fuel cell system 110 of the transport vehicle 104 supplies the electric power supply to the battery system 106 of the work machine 102 during transportation of the work machine 102 to different worksites. This way, the battery system 106 of the work machine 102 may be charged before the commencement of a work shift, which may reduce the downtime of the work machine 102 and may increase productivity at the worksite 101.

Further, in another example, the fuel cell system 110 of the transport vehicle 104 supplies the electric power supply to the battery system 106 of the work machine 102 when the transport vehicle 104 is in the parked state, i.e., when the work machine 102 is not being transported by the transport vehicle 104. The charging system 100 may allow charging of the work machine 102 at locations having limited access to grid power. Further, the charging system 100 may not require conventional grid connected charger for recharging the battery system 106 of the work machine 102.

The charging system 100 of the present disclosure may be cost-effective to implement, as the transport vehicle 104 that is being used to transport the work machine 102 to the worksite 101 as also supplies the electric power supply to the battery system 106 for charging the battery system 106. Thus, the charging system 100 may eliminate the need of transporting dedicated fuel cell systems (that are typically costly and bulky) or dedicated charging vehicles to worksites, that may reduce overall operational costs associated with work operations.

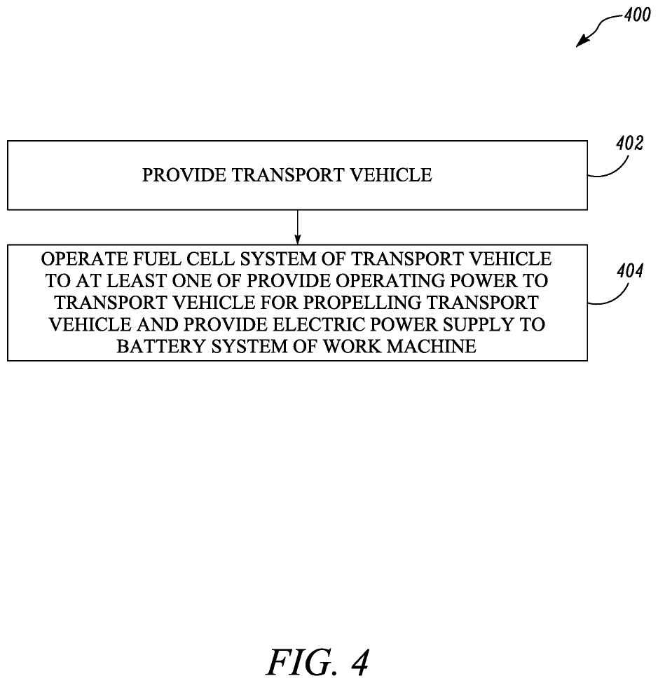

Further, the transport vehicle 104 may include a provision to hold multiple hydrogen tanks 126 thereon. The hydrogen tanks 126 may be used to store hydrogen fuel that may be supplied to the fuel cell system 110 to ensure propulsion of the transport vehicle 104 over longer distances, and also to provide the electric power supply to one or more work machines (such as, the work machines 102, 202, 302) at the worksite 101. The hydrogen tanks 126 stored on the transport vehicle 104 may eliminate transport of hydrogen tanks 126 separately to the worksite 101. The hydrogen tanks 126 may also eliminate the need of directing the transport vehicle 104 to other locations for hydrogen fuel refill. FIG. 4 illustrates a method 400 of charging the work machine 102, 202, 302. The work machine 102 includes the battery system 106, 206, 306. With reference to FIGS. 1, 2, and 4, at step 402, the transport vehicle 104 is provided. The transport vehicle 104 includes the on-highway vehicle. The work machine 102 is positioned on the transport vehicle 104 for transportation thereof. The transport vehicle 104 includes the fuel cell system 110.

At step 404, the fuel cell system 110 of the transport vehicle 104 is operated to provide the operating power to the transport vehicle 104 for propelling the transport vehicle 104 and/or to provide the electric power supply to the battery system 106 of the work machine 102.

The method 400 further includes a step of operating the fuel cell system 110 of the transport vehicle 104 to provide the electric power supply to the battery system 106 of the work machine 102 for charging the battery system 106 during the transportation of the work machine 102.

The method 400 further includes a step of operating the fuel cell system 110 of the transport vehicle 104 to provide the electric power supply to the battery system 106 of the work machine 102 for charging the battery system 106 when the work machine 102 is located at the worksite 101 and the transport vehicle 104 is in the parked state.

The method 400 further includes a step of providing the cable 128 having the first end 130 and the second end 132. The first end 130 of the cable 128 is coupled to the fuel cell system 110 of the transport vehicle 104 and the second end 132 of the cable 128 is coupled to the battery system 106 of the work machine 102. The method 400 further includes a step of supplying, via the cable 128, the electric power supply from the fuel cell system 110 to the battery system 106.

Referring now to FIGS. 2, 3, and 4, the method 400 further includes a step of operating the fuel cell system 110 of the transport vehicle 104 to provide the electric power supply to the battery systems 106, 206, 406 of the two or more work machines 102, 202, 402 for charging the battery systems 106, 206, 406 when the two or more work machines 102, 202, 402 are located at the worksite 101 and the transport vehicle 104 is in the parked state. The fuel cell system 110 provides the electric power supply to the battery systems 106, 206, 306 of the two or more work machines 102, 202, 402 simultaneously or in a sequential manner.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of the disclosure. Such embodiments should be understood to fall within the scope of the present disclosure as determined based upon the claims and any equivalents thereof.

What is claimed is:

1. A charging system comprising:
a work machine including a battery system; and
a transport vehicle adapted to transport the work machine, wherein the work machine is positioned on the transport vehicle for transportation thereof, the transport vehicle including a fuel cell system,
wherein the fuel cell system of the transport vehicle provides operating power to the transport vehicle for propelling the transport vehicle, and
wherein the fuel cell system further provides an electric power supply to the battery system of the work machine for charging the battery system.

2. The charging system of claim 1, wherein the fuel cell system provides the electric power supply to the battery system of the work machine for charging the battery system during the transportation of the work machine.

3. The charging system of claim 1, wherein the fuel cell system provides the electric power supply to the battery system of the work machine for charging the battery system when the work machine is located at a worksite and the transport vehicle is in a parked state.

4. The charging system of claim 1, further comprising a cable to supply the electric power supply from the fuel cell system to the battery system, the cable having a first end and a second end, wherein the first end of the cable is coupled to the fuel cell system of the transport vehicle and the second end of the cable is coupled to the battery system of the work machine.

5. The charging system of claim 1, wherein the transport vehicle further includes a hydrogen storage system to provide hydrogen fuel to the fuel cell system of the transport vehicle, and wherein the hydrogen storage system includes one or more hydrogen tanks.

6. The charging system of claim 1, wherein the transport vehicle further includes a mobile machine and a trailer that is driven by the mobile machine, and wherein the fuel cell system is disposed in the mobile machine.

7. The charging system of claim 1, wherein the work machine includes an off-highway machine and the transport vehicle includes an on-highway vehicle.

8. The charging system of claim 1, wherein the fuel cell system provides the electric power supply to battery systems of two or more work machines for charging the battery systems when the two or more work machines are located at a worksite and the transport vehicle is in a parked state, and wherein the fuel cell system is adapted to provide the electric power supply to the battery systems of the two or more work machines at least one of simultaneously and in a sequential manner.

9. A transport vehicle for transporting a work machine, the transport vehicle comprising:
a fuel cell system, wherein the fuel cell system of the transport vehicle provides operating power to the transport vehicle for propelling the transport vehicle, and wherein the fuel cell system further provides an electric power supply to a battery system of the work machine for charging the battery system; and
a cable to supply the electric power supply from the fuel cell system to the battery system, the cable having a first end and a second end, wherein the first end of the cable is coupled to the fuel cell system of the transport vehicle and the second end of the cable is coupled to the battery system of the work machine.

10. The transport vehicle of claim 9, wherein the fuel cell system provides the electric power supply to the battery system of the work machine for charging the battery system during the transportation of the work machine.

11. The transport vehicle of claim 9, wherein the fuel cell system provides the electric power supply to the battery system of the work machine for charging the battery system when the work machine is located at a worksite and the transport vehicle is in a parked state.

12. The transport vehicle of claim 9, wherein the transport vehicle further includes a hydrogen storage system to provide hydrogen fuel to the fuel cell system of the transport vehicle, and wherein the hydrogen storage system includes one or more hydrogen tanks.

13. The transport vehicle of claim 9, wherein the transport vehicle further includes a mobile machine and a trailer that is driven by the mobile machine, and wherein the fuel cell system is disposed in the mobile machine.

14. The transport vehicle of claim 9, wherein the work machine includes an off-highway machine and the transport vehicle includes an on-highway vehicle.

15. The transport vehicle of claim 9, wherein the fuel cell system provides the electric power supply to battery systems of two or more work machines for charging the battery systems when the two or more work machines are located at a worksite and the transport vehicle is in a parked state, and wherein the fuel cell system is adapted to provide the electric power supply to the battery systems of the two or more work machines at least one of simultaneously and in a sequential manner.

16. A method of charging a work machine, the work machine including a battery system, the method comprising:
providing a transport vehicle, wherein the transport vehicle is adapted to transport the work machine, wherein the work machine is positioned on the transport vehicle for transportation thereof, the transport vehicle including a fuel cell system; and
operating the fuel cell system of the transport vehicle to at least one of:
provide operating power to the transport vehicle for propelling the transport vehicle, and
provide an electric power supply to the battery system of the work machine.

17. The method of claim 16, further comprising operating the fuel cell system of the transport vehicle to provide the electric power supply to the battery system of the work machine for charging the battery system during the transportation of the work machine.

18. The method of claim 16, further comprising operating the fuel cell system of the transport vehicle to provide the electric power supply to the battery system of the work machine for charging the battery system when the work machine is located at a worksite and the transport vehicle is in a parked state.

19. The method of claim 16, further comprising:
providing a cable having a first end and a second end, wherein the first end of the cable is coupled to the fuel cell system of the transport vehicle and the second end of the cable is coupled to the battery system of the work machine; and
supplying, via the cable, the electric power supply from the fuel cell system to the battery system.

20. The method of claim 16, further comprising operating the fuel cell system of the transport vehicle to provide the electric power supply to battery systems of two or more work machines for charging the battery systems when the two or more work machines are located at a worksite and the transport vehicle is in a parked state, and wherein the fuel cell system is adapted to provide the electric power supply to the battery systems of the the two or more work machines at least one of simultaneously and in a sequential manner.
